(19) United States
(12) Patent Application Publication
(10) Pub. No.: US 2024/0294683 A1
(43) Pub. Date: Sep. 5, 2024

(54) PHOSPHORUS-CONTAINING RESIN AND FLAME-RETARDANT AND HEAT-RESISTANT COMPOSITION COMPRISING THE SAME

(71) Applicant: CHANG CHUN PLASTICS CO., LTD., Taipei City (TW)

(72) Inventors: Shihde YANG, Taipei City (TW); An-Pang TU, Taipei City (TW)

(21) Appl. No.: 18/581,413

(22) Filed: Feb. 20, 2024

Related U.S. Application Data
(60) Provisional application No. 63/447,364, filed on Feb. 22, 2023.

(30) Foreign Application Priority Data
Feb. 17, 2024 (TW) 113105667

(51) Int. Cl. C08F 212/34; C07F 9/6571; C08F 220/30; C08L 25/18; C08L 33/14

(52) U.S. Cl. CPC C08F 212/34; C07F 9/657172; C08F 220/305; C08L 25/18; C08L 33/14; C08L 2201/02

(57) ABSTRACT

A phosphorus-containing resin, wherein the phosphorus-containing resin comprises a structure as below:

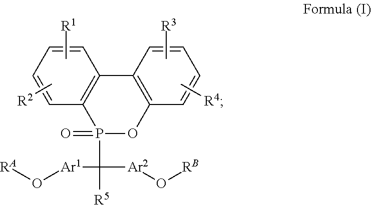

wherein R^{A} and R^{B} are each independently a phenylethene group; Ar¹, Ar² are each independently a bivalent arylene group. The phosphorus-containing resin of the instant disclosure has high reactivity, and may crosslink with other materials, making the flame-retardant and heat-resistant composition possess excellent flame-retardant and heat resistance effect, therefore having high industrial value.

### CROSS-REFERENCE TO RELATED APPLICATION

Pursuant to 35 U.S.C. § 119(a), this application claims the benefits of the priority to Taiwan Patent Application No. 113105667, filed Feb. 17, 2024, and pursuant to 35 U.S.C. § 119(e), this application claims the benefits of the priority to U.S. Provisional Patent Application No. 63/447,364, filed Feb. 22, 2023. The contents of the prior application are incorporated herein by its entirety.

### BACKGROUND OF THE INVENTION

### 1. Field of the Invention

The instant disclosure relates to a phosphorus-containing resin and a flame-retardant and heat-resistant composition comprising the same.

### 2. Description of the Prior Arts

In the development process of the electronic field, in order to improve the safety and reliability of telecommunications equipment and reduce the damage when a fire occurs, the industry is actively looking for methods to improve the flame-retardancy of resin materials. In the commonly used UL 94 specification, the industry generally aims to achieve a V0 level of the flame-retardant standard.

There are currently a variety of technologies that can be used to improve the flame-retardancy of resin materials. Traditionally, halogen containing flame-retardants are added to resin materials to improve their flame-retardant effect. However, halogen containing flame-retardants are corrosive and may release toxic hydrogen halide gas, causing environmental pollution and other problems. A number of international halogen-free regulations have been formulated to restrict the use of halogen-containing flame-retardants.

Therefore, the existing technology has developed a variety of phosphorus-containing flame-retardants to solve many problems derived from halogen-containing flame-retardants. Common phosphorus-containing flame-retardants on the market are such as: 2-(6-oxido-6H-dibenz[c,e][1,2]oxaphosphorin-6-yl)-1,4-benzenediol, 2,5-dihydroxyphenyldiphenylphosphine-oxide, 9,10-dihydro-9-oxa-10-phosphaphenanthrene-10-oxide (abbreviated as DOPO), and 4,4′-[1-(6-oxido-6H-dibenz[c,e][1,2]oxaphosphorin-6-yl)ethylidene]bisphenol (abbreviated as DMP).

Depending on how they are used, phosphorus-containing flame-retardants may be divided into two types, which are the additive type and the reactive type. Among them, additive type phosphorus-containing flame-retardants are mixed with resins in a physical blending method to form a flame-retardant composition. Common resins are such as epoxy resin, acrylonitrile-butadiene-styrene copolymer, polycarbonate, polyamide, polyethylene terephthalate, and polybutylene terephthalate. Depending on different product demands, additives such as adhesives, polymerization inhibitors, thickeners, defoaming agents, and fillers may also be added to the flame-retardant composition to adjust its characteristics.

While the physical blending of the additive type phosphorus-containing flame-retardant with other materials has the advantage of low processing cost, the physical force among flame-retardant and other materials makes electronic products extremely susceptible to migration phenomena caused by electron transmission and affect their stability and reliability. In addition, additive type phosphorus-containing flame-retardants require a high addition amount to exert the flame-retardant effect. Excessive phosphorus content may deteriorate the fluidity and uniformity of the flame-retardant composition in subsequent processing and dilute the content of other additives in the flame-retardant composition, further deteriorating its desired performance. Excessive phosphorus content may also cause serious burdens on the human body and the environment and hinder the subsequent application of the flame-retardants.

Different from the physical blending method, the reactive type phosphorus-containing flame-retardant is reacted and combined with other materials in the form of chemical bonding, which not only maintains a stable and long-lasting flame-retardant effect, but also improves the stability and reliability of electronic products. However, existing reactive type phosphorus-containing flame-retardants still require a certain amount of addition to reach the V0 level of the flame-retardant standard, resulting in flame-retardant compositions or subsequent application products still having the problem of high phosphorus content.

Regardless of additive or reactive type phosphorus-containing flame-retardants, existing phosphorus-containing flame-retardants generally have poor heat resistance, which hinders the application of phosphorus-containing flame-retardants and flame-retardant compositions comprising the same in subsequent substrate manufacturing process and even affects the overall performance of electronic products.

In view of the above-mentioned defects of the phosphorus-containing flame-retardants, a new phosphorus-containing flame-retardant still needs to be developed to comprehensively improve its reactivity, flame resistance, and heat resistance.

### SUMMARY OF THE INVENTION

In view of this, an objective of the instant disclosure is to improve the reactivity between the phosphorus-containing flame-retardant and other materials, providing a stable and long-lasting flame-retardant and heat-resistant effects.

Another objective of the instant disclosure is to further improve the flame-retardant and heat-resistant effects of the phosphorus-containing flame-retardant and the flame-retardant composition comprising the same while reducing the amount of the phosphorus-containing flame-retardant as much as possible.

To achieve aforementioned objective, the instant disclosure provides a phosphorus-containing resin, wherein the phosphorus-containing resin comprises a structure as below:

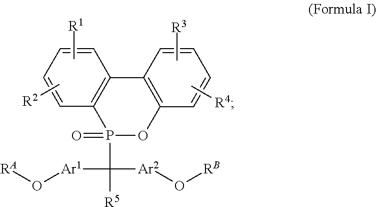

wherein R¹, R², R³, and R⁴ are each independently selected from the group consisting of a hydrogen atom, an alkyl group having 1 to 6 carbon atoms, an alkoxy group having 1 to 6 carbon atoms, and a cycloalkyl group having 3 to 6 carbon atoms;

R⁵ is selected from the group consisting of an alkyl group having 1 to 6 carbon atoms, an alkoxy group having 1 to 6 carbon atoms, a cycloalkyl group having 3 to 6 carbon atoms, and Ar³;

R^{A} and R^{B} are each independently

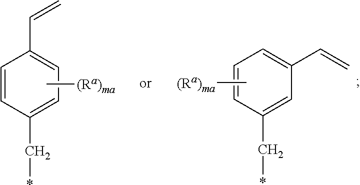

Ar¹ and Ar² are each independently selected from the group consisting of

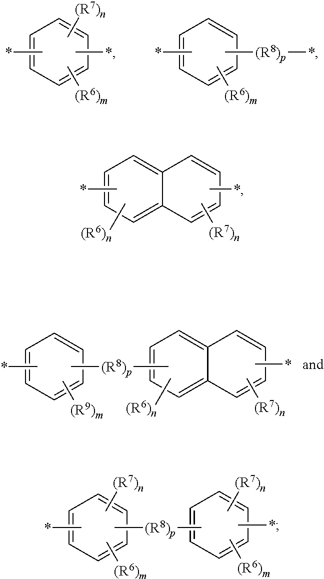

Ar³ is selected from the group consisting of

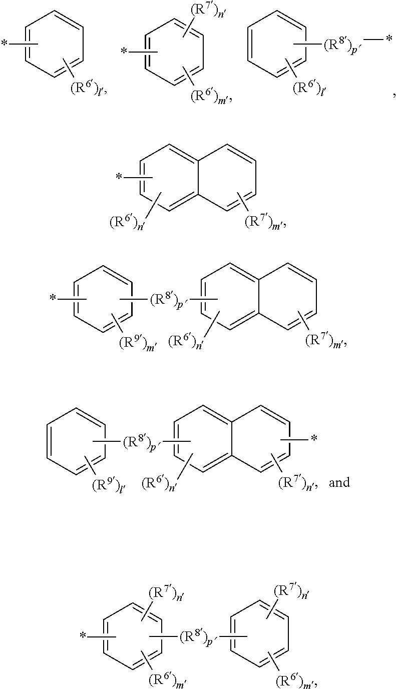

R⁶, R⁷, R⁹, R^{6′}, R^{7′}, R^{9′}, and R^{a} are each independently selected from the group consisting of an alkyl group having 1 to 6 carbon atoms, an alkoxy group having 1 to 6 carbon atoms, and a cycloalkyl group having 3 to 6 carbon atoms;
R⁸ and R^{8′} are each independently selected from the group consisting of —CH₂—, —C(CH₃)₂—, —CO—, —SO₂—, and —O—;
l′ is an integer of 0 to 5;
m, m′ and ma are each independently an integer of 0 to 4;
n and n′ are an integer of 0 to 3;
p and p′ are 0 or 1;
the sum of m and n is not more than 4;
the sum of m′ and n′ is not more than 5; and
*represents the bonding site.

With its terminal styrene group, the phosphorus-containing resin of the instant disclosure has good reactivity and may crosslink with other resin materials to form a flame-retardant and heat-resistant composition, thereby providing stable and long-term flame-retardant effect. It may also be prepared into a composition with low phosphorus content and excellent flame-retardant and heat-resistant effects, making the phosphorus-containing resin of the instant disclosure particularly suitable as a phosphorus-containing flame-retardant, which possesses industrial value of high reactivity, high flame resistance, and high heat resistance.

R¹, R², R³, R⁴, R⁵, R⁶, R⁷, R⁹, R⁶, R⁷, R⁹, and R^{a} each may be an alkyl group having 1 to 6 carbon atoms, an alkoxy group having 1 to 6 carbon atoms, or a cycloalkyl group having 3 to 6 carbon atoms, and R¹, R², R³, R⁴, R⁵, R⁶, R⁷, R⁹, R⁶, R⁷, and R⁹, R^{a} may be the same or different structures. In some embodiments, the alkyl group with 1 to 6 carbon atoms may be an alkyl group with 1, 2, 3, 4, 5 or 6 carbon atoms; the alkyl group with 1 to 4 carbon atoms may be an alkyl group with 1, 2, 3, or 4 carbon atoms, such as methyl, ethyl, n-propyl, isopropyl, n-butyl or tert-butyl, but is not limited thereto. The alkoxy group having 1 to 6 carbon atoms may be an alkoxy group having 1, 2, 3, 4, 5 or 6 carbon atoms; the alkoxy group having 1 to 4 carbon atoms may be an alkoxy group with 1, 2, 3 or 4 carbon atoms, such as methoxy, ethoxy, or propoxy, but is not limited thereto. The cycloalkyl group having 3 to 6 carbon atoms may be a cycloalkyl group having 3, 4, 5 or 6 carbon atoms, such as cyclopropyl group, but is not limited thereto. In addition, R¹, R², R³, and R⁴ each may be a hydrogen atom, and R⁵ may also be Ar³.

In some embodiments, R^{A} and R^{B} each may be

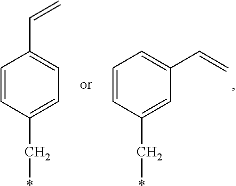

R^{A} and R^{B} may be the same or different structures.

In some embodiments, l′ may be an integer from 0 to 5; m, m′, and ma each may be independently an integer from 0 to 4; n and n′ may be an integer from 0 to 3; and p and p′ may be 0 or 1. The sum of m and n may not exceed 4, and the sum of m′ and n′ may not exceed 5. Specifically, l′ is 0, 1, 2, 3, 4 or 5; m, m′, and ma are each independently 0, 1, 2, 3 or 4; and n and n′ are each independently 0, 1, 2 or 3. The sum of m and n is 0, 1, 2, 3 or 4, and the sum of m′ and n′ is 0, 1, 2, 3, 4 or 5.

In some embodiments of the instant disclosure, Ar¹ and Ar² may each independently be

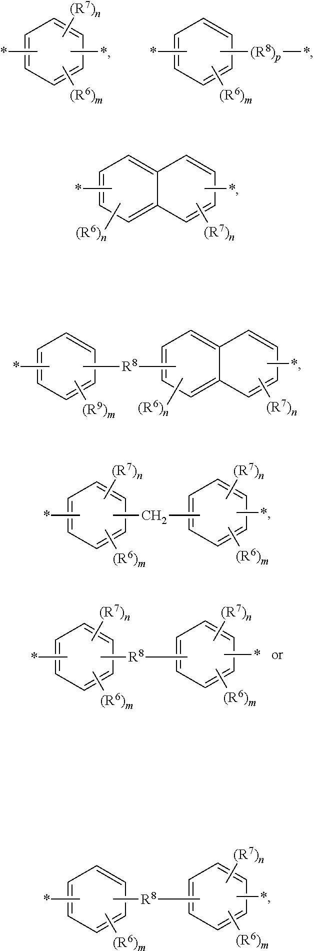

and Ar¹ and Ar² may be the same or different structures, wherein, R⁶, R⁷, and R⁹ may each be an alkyl group with 1 to 4 carbon atoms, an alkoxy group with 1 to 4 carbon atoms, or a cycloalkyl group with 3 to 6 carbon atoms, R⁸ may be —CH₂—, —C(CH₃)₂—, —CO—, —SO₂— or —O—, and m, n, and p may each independently be 0 or 1.

In some embodiments of the instant disclosure, Ar³ may be

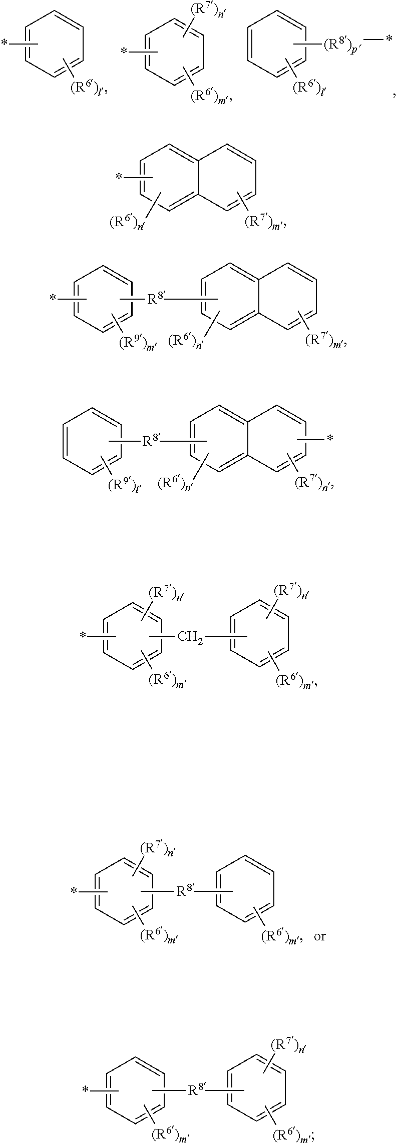

R⁶, R⁷, and R^{9′} may each be an alkyl group with 1 to 4 carbon atoms, an alkoxy group with 1 to 4 carbon atoms, or a cycloalkyl group with 3 to 6 carbon atoms, R^{8′} may be —CH₂—, —C(CH₃)₂—, —CO—, —SO₂— or —O—, and I′, m′, n′ and p′ may each independently be 0 or 1.

In one of the embodiments, the phosphorus-containing resin as shown in Formula (I) has R¹, R², R³, R⁴, and R⁵ each being a hydrogen atom, Ar¹ and Ar² each being

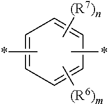

with n and m each being 0, and R^{A} and R^{B} each being

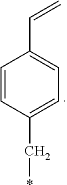 [SMILES: *Cc1ccc(C=C)cc1]

For example, the phosphorus-containing resin as shown in Formula (I) comprises the structure as shown in Formula (Ia) below:

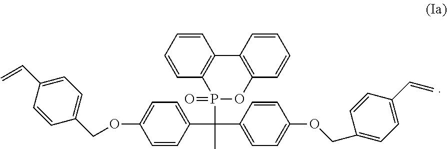 [SMILES: C=Cc1ccc(COc2ccc(C(C)(c3ccc(OCc4ccc(C=C)cc4)cc3)P3(=O)Oc4ccccc4-c4ccccc43)cc2)cc1]

In one of the embodiments, the phosphorus-containing resin as shown in Formula (I) has R¹, R², R³, R⁴, and R⁵ each being a hydrogen atom, Ar¹ and Ar² each being

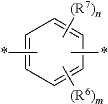

with n and m each being 0, and R^{A} and R^{B} each being

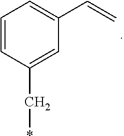 [SMILES: *Cc1cccc(C=C)c1]

For example, the phosphorus-containing resin as shown in Formula (I) comprises the structure as shown in Formula (Ib) below:

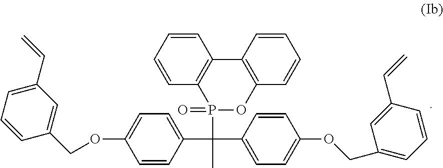 [SMILES: C=Cc1cccc(COc2ccc(C(C)(c3ccc(OCc4cccc(C=C)c4)cc3)P3(=O)Oc4ccccc4-c4ccccc43)cc2)c1]

In one of the embodiments, the phosphorus-containing resin as shown in Formula (I) has R¹, R², R³, R⁴, and R⁵ each being a hydrogen atom, Ar¹ and Ar² each being

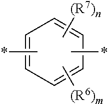

with n and m each being 0, R^{A} being

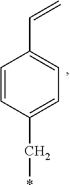 [SMILES: *Cc1ccc(C=C)cc1]

and R^{B} being

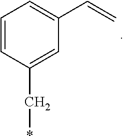 [SMILES: *Cc1cccc(C=C)c1]

For example, the phosphorus-containing resin as shown in Formula (I) comprises the structure as shown in Formula (Ic) below:

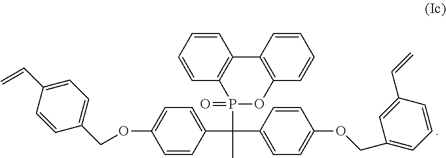 [SMILES: C=Cc1ccc(COc2ccc(C(C)(c3ccc(OCc4cccc(C=C)c4)cc3)P3(=O)Oc4ccccc4-c4ccccc43)cc2)cc1]

In one of the embodiments, the phosphorus-containing resin comprises phosphorus-containing resins of Formula (Ia), Formula (Ib), and Formula (Ic) as described above.

According to the instant disclosure, the phosphorus-containing resin may have a phosphorus content of less than 5 wt %. Preferably, the phosphorus content of the phosphorus-containing resin may be more than 1 wt % and less than 5 wt %. The phosphorus content of the phosphorus-containing resin May be any of the following values, such as 1.5 wt %, 2.0 wt %, 2.5 wt %, 3.0 wt %, 3.5 wt %, 4.0 wt %, 4.5 wt %, . . . , 4.9 wt %, 4.91 wt %, 4.92 wt %, 4.93 wt %, 4.94 wt %, 4.95 wt %, 4.96 wt %, 4.97 wt %, 4.98 wt %, 4.99 wt %, but is not limited thereto. The above specific values may be used as endpoints of other numerical ranges.

According to the instant disclosure, the integral value of the characteristic peak located at 4.95 ppm to 6.00 ppm in the hydrogen-1 nuclear magnetic resonance (1H-NMR) spectrum of the phosphorus-containing resin is 10% to 20% relative to a total integral value of characteristic peaks of hydrogen atoms of the phosphorus-containing resin. Specifically, the integral value of the characteristic peak located at 4.95 ppm to 6.00 ppm relative to a total integral value of characteristic peaks of hydrogen atoms in the 1H-NMR spectrum of the phosphorus-containing resin may be any of the following values, such as 10%, 11%, 12%, 13%, 14%, 15%, 16%, 17%, 18%, 19%, 20%, but is not limited thereto. The above specific values may be used as endpoints of other numerical ranges.

According to the instant disclosure, the number average molecular weight (Mn) of the phosphorus-containing resin is between 425 g/mol and 470 g/mol, and the weight average molecular weight (Mw) of the phosphorus-containing resin is between 425 g/mol and 470 g/mol. The ratio of the weight average molecular weight to the number average molecular weight (Mw/Mn) represents polydispersity index (PDI), and the PDI of the phosphorus-containing resin may be less than or equal to 1.10. Specifically, the PDI of the phosphorus-containing resin may be between 0.99 and 1.10, indicating less amount of byproducts in the phosphorus-containing resin of the instant disclosure.

According to the instant disclosure, the Fourier-transform infrared (FT-IR) spectrum of the phosphorus-containing resin has an absorption peak at 1600 cm-1 to 1700 cm-1 corresponding to C═C of alkene.

According to the instant disclosure, the FT-IR spectrum of the phosphorus-containing resin has an absorption peak at 1240 cm⁻¹ to 1250 cm⁻¹ corresponding to an aromatic C—O moiety.

According to the instant disclosure, the FT-IR spectrum of the phosphorus-containing resin has an absorption peak at 1000 cm⁻¹ to 1100 cm⁻¹ corresponding to a saturated C—O moiety. More specifically, the FT-IR spectrum of the phosphorus-containing resin has an absorption peak at 1010 cm⁻¹ to 1050 cm⁻¹ corresponding to a saturated C—O moiety.

According to the instant disclosure, the FT-IR spectrum of the phosphorus-containing resin has an absorption peak at 1180 cm⁻¹ to 1195 cm⁻¹ corresponding to a P—O-Ph moiety.

The instant disclosure also provides a flame-retardant and heat-resistant composition, comprising a main resin and an aforesaid phosphorus-containing resin as described in Formula (I).

According to the instant disclosure, based on the total weight of the overall flame-retardant and heat-resistant composition, the amount of the phosphorus-containing resin of the flame-retardant and heat-resistant composition is 5 wt % to 50 wt %. Specifically, the amount of the phosphorus-containing resin may be 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, but is not limited thereto. The above specific values may be used as endpoints of other numerical ranges.

According to the instant disclosure, the main resin comprises polyphenylene oxide-based resin, maleimide-based resin, or a combination thereof. In one of the embodiments, the polyphenylene oxide-based resin may comprise, but is not limited to, polyphenylene oxide resin, bishydroxyl polyphenylene oxide resin (such as SA90, purchased from Sabic Corporation), methacrylate polyphenylene oxide resin (such as SA9000, purchased from Sabic Corporation), vinyl polyphenylene oxide resin (such as OPE-2st, purchased from Mitsubishi Gas Chemical Corporation), or a combination thereof. Among them, the polyphenylene oxide-based resin is preferably vinyl polyphenylene oxide resin. For example, the vinyl polyphenylene oxide resin may comprise vinyl benzyl polyphenylene oxide resin, vinyl benzyl modified bisphenol A polyphenylene oxide resin, vinyl chain extension polyphenylene oxide resin, or a combination thereof, but is not limited thereto. The polyphenylene oxide-based resin may be mixed with a phosphorus-containing resin to form a low dielectric flame-retardant and heat-resistant composition. In another embodiment, the maleimide-based resin is a compound with more than one maleimide functional group (monofunctional maleimide compound, bifunctional maleimide compound, polyfunctional maleimide compound), monomers, mixtures, or polymers (including oligomers). The maleimide-based resin may be maleimide-based resins suitable for making prepregs, resin films, laminates, printed circuit boards, or a combination thereof. For example, the maleimide-based resin may comprise, but is not limited to, 4,4′-diphenylmethanebismaleimide (CAS No.: 13676-54-5), phenylmethane maleimide oligomer (or polyphenylmethane maleimide, CAS number: 105391-33-1), bismaleimidetoluene, diethyl bismaleimide toluene, m-phenylene bismaleimide, bisphenol A diphenyl ether bismaleimide (or 2,2′-bis-[4-(4-maleimidephenoxy)phenyl]propane, CAS No.: 79922-55-7), 3,3′-dimethyl-5,5′-diethyl-4,4′-diphenylmethane bismaleimide, bis(3-ethyl-5-methyl-4-maleimidophenyl)methane (CAS No.: 105391-33-1), 4-methyl-1,3-phenylbismaleimide (CAS No.: 6422-83-9), 1,6-bismaleimide-(2,2,4-trimethyl)hexane, 2,3-dimethylbenzenemaleimide, 2,6-dimethylbenzenemaleimide, N-phenylmaleimide (CAS No.: 941-69-5), or a combination thereof, but is not limited thereto. The maleimide-based resin May also comprise, but is not limited to, a maleimide resin having a biphenyl structure, a maleimide resin having an aliphatic long chain structure, or a combination thereof. In addition, the maleimide-based resin may also comprise prepolymers of the aforementioned maleimide resin and other compounds. For example, the other compounds may be, but are not limited to, diallyl compounds, multifunctional amines (including diamines), acidic phenolic compounds, or a combination thereof. The maleimide-based resin may also be mixed with a phosphorus-containing resin to form a highly dimensionally stable flame-retardant and heat-resistant composition. The styrene group at the terminal of the phosphorus-containing resin may react with the main resin and crosslink to form flame-retardant and heat-resistant compositions with different characteristics, thereby obtaining good reactivity. Preferably, the nitrogen element in the maleimide-based resin may decrease the oxygen density of the flame-retardant and heat-resistant composition during burning decomposition, which makes the composition exhibit both flame-retardant and heat-resistant effects under conditions of low phosphorus content.

Optionally, the flame-retardant and heat-resistant composition May further comprise components other than the above-mentioned main resin. Specifically, the components may comprise styryl-dicyclopentadienyl phenyl ether, cyanate ester resin, active ester, divinyl benzyl ether, 1,2-bis(vinylphenyl)ethane, divinylbenzene, triallyl isocyanurate, triallyl cyanurate, 1,2,4-trivinylcyclohexane, diallylbisphenol A, styrene, acrylate, polyolefin, epoxy resin, phenol resin, styrene maleic anhydride resin, amine curing agent, polyamide, polyimide, or a combination thereof, but is not limited thereto. For example, the flame-retardant and heat-resistant composition may further comprise modifications of the above components.

According to the instant disclosure, the flame-retardant and heat-resistant composition has a phosphorus content of 0.5 wt % to 1.5 wt %. Specifically, the phosphorus content of the flame-retardant and heat-resistant composition may be 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, but is not limited thereto. The above specific values may be used as endpoints of other numerical ranges.

According to the instant disclosure, the terminal styrene group of the phosphorus-containing resin in the flame-retardant and heat-resistant composition is conducive to the addition reaction with the main resin to form covalent bonds and may help improve the distribution uniformity on the covalent bonds, thereby enhancing the thermal stability and making the flame-retardant and heat-resistant composition obtain a higher glass transition temperature (Tg). Specifically, the flame-retardant and heat-resistant composition may have a glass transition temperature (Tg) more than or equal to 190° C. or more than or equal to 200° C. Preferably, the glass transition temperature of the flame-retardant and heat-resistant composition may be 190° C. to 300° C. The glass transition temperature of the flame-retardant and heat-resistant composition may be 190° C., 200° C., 210° C., 220° C., 230° C., 240° C., 250° C., 260° C., 270° C., 280° C., 290° C., 300° C., but is not limited thereto. The above specific values may be used as endpoints of other numerical ranges. Accordingly, the flame-retardant and heat-resistant composition of the instant disclosure possesses better heat resistance to meet the subsequent processing requirements of soft or hard boards.

### BRIEF DESCRIPTION OF THE DRAWING(S)

FIG. 1 is the FT-IR spectrum of Comparative Example 2.

FIG. 2 is the FT-IR spectrum of Example 1.

FIG. 3 is the FT-IR spectrum of Example 2.

FIG. 4 is the 1H-NMR spectrum of Example 1.

FIG. 5 is the 1H-NMR spectrum of Example 2.

### DETAILED DESCRIPTION OF THE PREFERRED EMBODIMENTS

Based on the phosphorus-containing resin and the flame-retardant and heat-resistant composition comprising the same as provided by the instant disclosure, the inventor found that by substituting the terminal hydroxyl group of 6-(1,1-bis(4-hydroxyphenyl)ethyl)dibenzo[c, e][1,2]oxaphosphinine-6-oxide (abbreviated as DMP, CAS No.: 1205686-58-3) with a styrene group and form the phosphorus-containing resin of the instant disclosure (hereinafter referred to as DMPDS), the phosphorus-containing resin of the instant disclosure May have high reactivity, which may not only self-crosslink and solidify, but May also polymerize with a variety of resin materials, forming a flame-retardant and heat-resistant composition exhibiting both flame-retardant and heat-resistant effects.

More specifically, by adding the phosphorus-containing resin into a main resin, the phosphorus-containing resin and the main resin may form chemical boding and obtain a flame-retardant and heat-resistant composition with excellent flame-retardant and heat-resistant effects through cross-linking reaction, with the flame-retardant and heat-resistant composition having a low phosphorus content.

The instant disclosure provides a phosphorus-containing resin as shown in Formula (I):

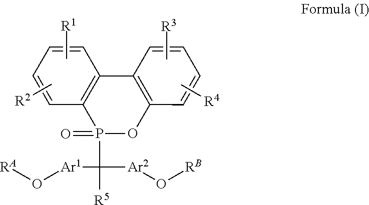

In some embodiments, R¹, R², R³, and R⁴ each may be independently selected from the group consisting of a hydrogen atom, an alkyl group having 1 to 6 carbon atoms, an alkoxy group having 1 to 6 carbon atoms, and a cycloalkyl group having 3 to 6 carbon atoms, wherein, R¹, R², R³, and R⁴ may have mutually different structures, but in some embodiments, R¹, R², R³, and R⁴ may have the same structure among the two or the three, or, R¹, R², R³, and R⁴ may have the same structure. R¹, R², R³, and R⁴ may be each independently selected from the group consisting of a hydrogen atom, a substituted alkyl group having 1 to 6 carbon atoms, an unsubstituted alkyl group having 1 to 6 carbon atoms, a substituted alkoxy group having 1 to 6 carbon atoms, an unsubstituted alkoxy group having 1 to 6 carbon atoms, a substituted cycloalkyl group having 3 to 6 carbon atoms, and an unsubstituted cycloalkyl group having 3 to 6 carbon atoms. For example, R¹, R², R³, and R⁴ may be substituted or unsubstituted alkyl groups with a carbon number of 6, 5, 4, 3, 2, 1 or any range between the two aforementioned; R¹, R², R³, and R⁴ may be substituted or unsubstituted alkoxy groups with carbon numbers of 6, 5, 4, 3, 2, 1 or any range between the two aforementioned; and alternatively, R¹, R², R³, and R⁴ may be substituted or unsubstituted cycloalkyl groups with a carbon number of 6, 5, 4, 3 or any range between the two aforementioned. In some embodiments of the instant disclosure, R¹, R², R³, and R⁴ may be each independently selected from the group consisting of a hydrogen atom, methyl, ethyl, isopropyl, n-propyl, n-butyl and tert-butyl. In other embodiments, R¹, R², R³, and R⁴ are hydrogen atoms.

In some embodiments, R⁵ may be selected from the group consisting of an alkyl group having 1 to 6 carbon atoms, an alkoxy group having 1 to 6 carbon atoms, and a cycloalkyl group having 3 to 6 carbon atoms. For example, R⁵ may be substituted or unsubstituted alkyl groups with a carbon number of 6, 5, 4, 3, 2, 1 or any range between the two aforementioned; R⁵ may be substituted or unsubstituted alkoxy groups with carbon numbers of 6, 5, 4, 3, 2, 1 or any range between the two aforementioned; and alternatively, R⁵ may be substituted or unsubstituted cycloalkyl groups with a carbon number of 6, 5, 4, 3 or any range between the two aforementioned. In some embodiments of the instant disclosure, R⁵ may be independently selected from the group consisting of methyl, ethyl, isopropyl, n-propyl, n-butyl, and tert-butyl. Besides, R⁵ may also be Ar³, and Ar³ may be selected from the group consisting of

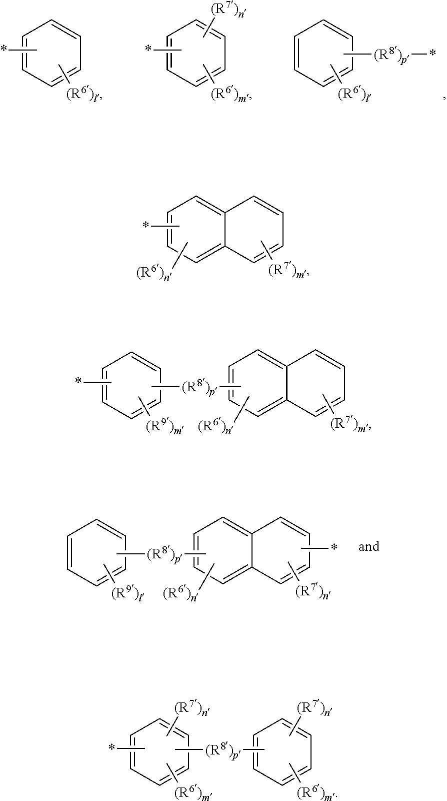

In some embodiments, R^{6′}, R⁷, and R⁹ each may be independently selected from the group consisting of an alkyl group having 1 to 6 carbon atoms, an alkoxy group having 1 to 6 carbon atoms, and a cycloalkyl group having 3 to 6 carbon atoms, wherein, R^{6′}, R⁷, and R⁹ may have mutually different structures, but in some embodiments, any two among R^{6′}, R⁷, and R^{9′} may have the same structure, or, R^{6′}, R⁷, and R⁹ may have the same structure. For example, R^{6′}, R⁷, and R⁹ may be substituted or unsubstituted alkyl groups with a carbon number of 6, 5, 4, 3, 2, 1 or any range between the two aforementioned; R^{6′}, R⁷, and R⁹ may be substituted or unsubstituted alkoxy groups with carbon numbers of 6, 5, 4, 3, 2, 1 or any range between the two aforementioned; and alternatively, R^{6′}, R⁷, and R⁹ may be substituted or unsubstituted cycloalkyl groups with a carbon number of 6, 5, 4, 3 or any range between the two aforementioned. In some embodiments of the instant disclosure, R^{6′}, R⁷, and R⁹ each may be independently selected from the group consisting of methyl, ethyl, isopropyl, n-propyl, n-butyl and tert-butyl.

Generally, R^{A} and R^{B} may be each independently

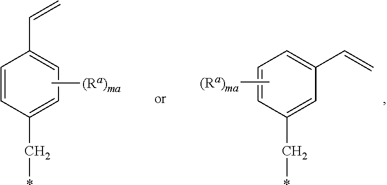

wherein, R^{A} and R^{B} may have different structures, but in some embodiments, R^{A} and R^{B} may have the same structure.

In some embodiments, R^{a} may be selected from the group consisting of an alkyl group having 1 to 6 carbon atoms, an alkoxy group having 1 to 6 carbon atoms, and a cycloalkyl group having 3 to 6 carbon atoms. For example, R^{a} may be substituted or unsubstituted alkyl groups with a carbon number of 6, 5, 4, 3, 2, 1 or any range between the two aforementioned; R^{a} may be substituted or unsubstituted alkoxy groups with carbon numbers of 6, 5, 4, 3, 2, 1 or any range between the two aforementioned; alternatively, R^{a} may be substituted or unsubstituted cycloalkyl groups with a carbon number of 6, 5, 4, or any range between the two aforementioned. In some embodiments of the instant disclosure, R^{a} may be independently selected from the group consisting of methyl, ethyl, isopropyl, n-propyl, n-butyl, and tert-butyl. In one of the embodiments, R^{A} and R^{B} each may be

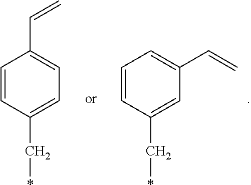

Generally, Ar¹ and Ar² each may be independently selected from the group consisting of

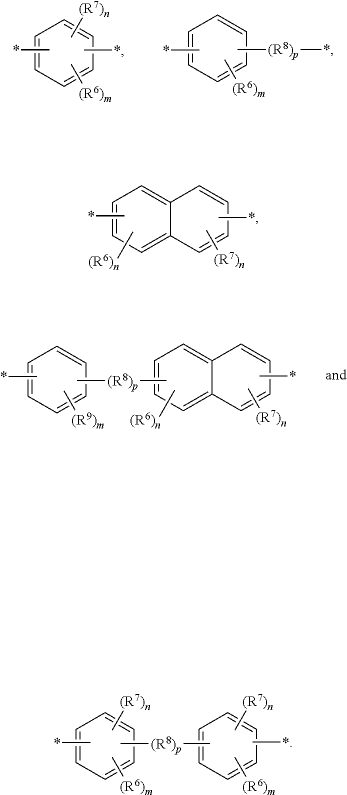

Ar¹ and Ar² may have the same or different structures. R⁶, R⁷, and R⁹ each may be independently selected from the group consisting of an alkyl group having 1 to 6 carbon atoms, an alkoxy group having 1 to 6 carbon atoms, and a cycloalkyl group having 3 to 6 carbon atoms, wherein, R⁶, R⁷, and R⁹ may have mutually different structures, but in some embodiments, any two among R⁶, R⁷, and R⁹ may have the same structure, or, R⁶, R⁷, and R⁹ may have the same structure. R⁶, R⁷, and R⁹ each may be substituted or unsubstituted alkyl groups with a carbon number of 6, 5, 4, 3, 2, 1 or any range between the two aforementioned; R⁶, R⁷, and R⁹ each may be substituted or unsubstituted alkoxy groups with carbon numbers of 6, 5, 4, 3, 2, 1 or any range between the two aforementioned; and alternatively, R⁶, R⁷, and R⁹ each may be substituted or unsubstituted cycloalkyl groups with a carbon number of 6, 5, 4, 3 or any range between the two aforementioned. In some embodiments of the instant disclosure, R⁶, R⁷, and R⁹ each may be independently selected from the group consisting of methyl, ethyl, isopropyl, n-propyl, n-butyl and tert-butyl.

R⁸ and R^{8′} may be each independently selected from the group consisting of —CH₂—, —C(CH₃)₂—, —CO—, —SO₂—, and —O— or a covalent bond. It is understood that when the p of —(R⁸)ₚ— is 0 or the p′ of —(R^{8′})ₚ— is 0, the —(R⁸)ₚ— or the —(R^{8′})ₚ— may be represented as the covalent bond, which is a bonding bond to connect two groups with no other substituents existing.

l′ may be an integer from 0 to 5; m, m′, and ma each may be independently an integer from 0 to 4; n and n′ may be an integer from 0 to 3; and p and p′ may be 0 or 1. The sum of m and n may not exceed 4, and the sum of m′ and n′ may not exceed 5. Specifically, l′ may be independently 0, 1, 2, 3, 4 or 5; m, m′ and ma each may be independently 0, 1, 2, 3 or 4; and n and n′ each may be independently 0, 1, 2 or 3. The sum of m and n may be 0, 1, 2, 3 or 4, and the sum of m′ and n′ may be 0, 1, 2, 3, 4 or 5.

### Reagent Description:

CMS-P:comprising 45 wt % to 55 wt % of 4-chloromethyl styrene (CAS NO.: 1592-20-7), 45 wt % to 55 wt % of 3-chloromethylstyrene (3-chloromethyl styrene, CAS No.: 39833-65-3), and impurities (such as dichlorostyrene) between 0 wt % and 2 wt %.

CMS-14: comprising 95 wt % of 4-chloromethylstyrene, 5 wt % of 3-chloromethylstyrene, and impurities (such as dichlorostyrene) between 0 wt % and 2 wt %.

Several comparative examples and embodiments are listed below to illustrate the implementation of the instant disclosure. Those familiar with this art can easily understand the advantages and effects that the instant disclosure may achieve through the contents of this specification.

### Comparative Example 1

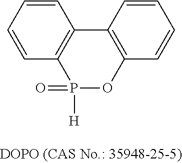 [SMILES: O=[PH]1Oc2ccccc2-c2ccccc21]

Comparative Example 1 was purchased directly from Taiwan Sanko Co., Ltd., or may be purchased from Japan Sanko Co., Ltd., whose trade name is HCA.

The DOPO of Comparative Example 1 was used as the test sample, and 1 mg of the test sample was applied to a potassium bromide (KBr) tablet with a diameter of 13 mm and a thickness of 1 mm by a thin film method. The coated KBr tablet was placed into a tablet holder and then placed in a Fourier transform infrared (FT-IR) spectrometer (model: Spotlight 200i; instrument manufacturer: PerkinElmer). The coated KBr tablet was measured in the range of 400 cm⁻¹ to 4000 cm⁻¹ of the absorption spectrum, and the spectral intensity was measured by the transmission method, in which the resolution of the FT-IR spectrometer was 1 cm⁻¹, the cumulative number of the spectrum was 16 times, the spectral intensity was the absorbance at each wavelength (in arbitrary unit), and the calculation method was the integrated area of the line connecting the starting point and the end point of the peak within the specified range, wherein, P represented phosphorus, H represented hydrogen, O represented oxygen, Ph represented benzene, and C represented carbon.

After the FT-IR analysis, it was observed that there was an obvious P—O-Ph absorption characteristic peak at 1193 cm⁻¹, an obvious P-Ph absorption characteristic peak at 1442 cm⁻¹, an obvious P—H absorption characteristic peaks at 2436 cm⁻¹, and an obvious P═O absorption characteristic peak at 1425 cm⁻¹.

### Comparative Example 2

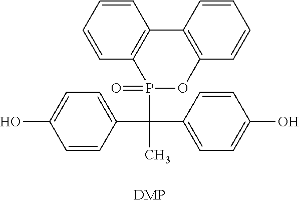 [SMILES: CC(c1ccc(O)cc1)(c1ccc(O)cc1)P1(=O)Oc2ccccc2-c2ccccc21]

In a three-neck reaction flask of 3000 ml, 216.2 g (1 mol) of 9,10-dihydro-9-oxa-10-phosphaphenanthrene-10-oxide (DOPO, CAS No.: 35948-25-5), 470.5 g (5 mol) of phenol, 136.2 g (1 mol) of 4′-hydroxyacetophenone, and 8.65 g (4 wt % of the weight of DOPO) of p-toluenesulfonic acid were premixed at room temperature. Then, the foresaid reactants were continuingly mixed for 6 hours at 130° C. to obtain a mixture. After the temperature was cooled to room temperature, the mixture was separated to obtain a primary product. The primary product was washed with ethanol and was filtrated and dried to obtain white powder. The white powder was DMP of Comparative Example 2, whose structure is presented above.

The aforementioned Comparative Example 2 had a yield of 85%, and its melting point was 306° C. The measurement result of the elemental analysis of Comparative Example 2 was that carbon, hydrogen, and oxygen elements were 72.48%, 4.65% and 14.90%, respectively, and the theoretical content of carbon, hydrogen, and oxygen elements were 72.89%, 4.65% and 14.94%, respectively.

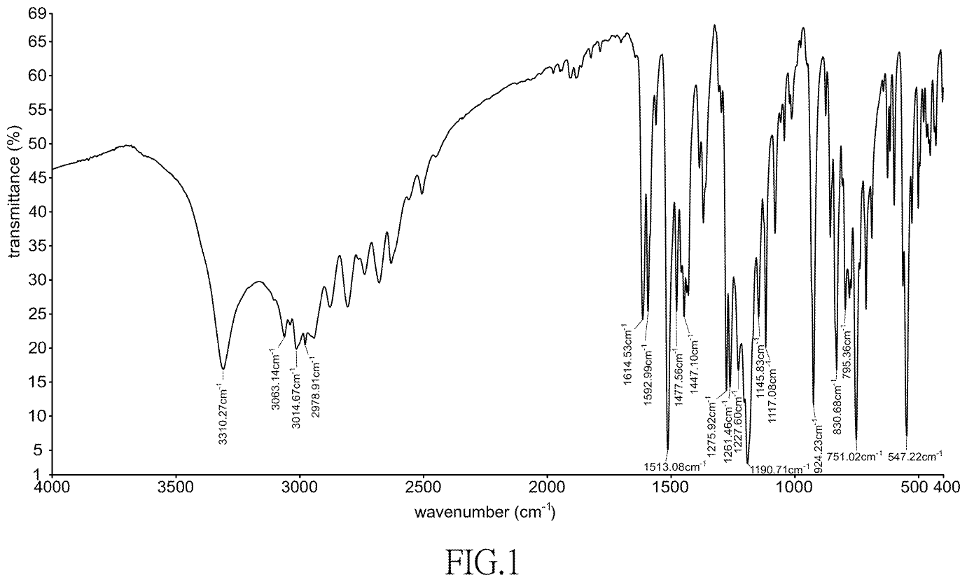

After the same FT-IR analysis method as mentioned above, with reference to FIG. 1, it was observed that there was an obvious P—O-Ph absorption characteristic peak at 1191 cm⁻¹ and an obvious Ph-OH absorption characteristic peak at 3300 cm⁻¹ to 3370 cm⁻¹. The P—H absorption characteristic peak at 2436 cm⁻¹ was not observed, the aromatic C—O absorption characteristic peak at 1247 cm⁻¹ was not observed, and the saturated C—O absorption characteristic peak at 1014 cm⁻¹ was not observed either.

### Comparative Example 3

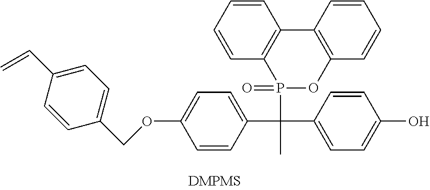 [SMILES: C=Cc1ccc(COc2ccc(C(C)(c3ccc(O)cc3)P3(=O)Oc4ccccc4-c4ccccc43)cc2)cc1]

428 g of DMP (as Comparative Example 2 mentioned above) was dissolved in 1 kg of dimethyl sulfoxide (DMSO, CAS No.: 67-68-5), and then 176 g of 50% (vol %) sodium hydroxide (NaOH, CAS No.: 1310-73-2) was added and mixed in uniform. 76 g (about 0.5 eq) of CMS-P/0.2 g of 4-methoxyphenol (hydroquinone monomethyl ether, abbreviated as MEHQ, CAS No.: 150-76-5) was dipped into the mixture at 65° C. until the reaction was completed. After cooling, the product Comparative Example 3 was obtained, whose main product is DMPMS as shown above.

15 mg of Comparative Example 3 was used as a test sample and was dissolved in 750 ml of deuterated dimethyl sulfoxide, and the resulting solution was placed in a sample feeder of the nuclear magnetic resonance instrument (model: Bruker AVANCE 500 NMR). After shimming, a 5 mm probe (model: BBFO Smart probe) was used for analysis. The resonance frequency was 500 MHz, the pulse width was 10 microseconds, the pulse delay time was 2 seconds, the accumulation number was 32 times, and the signal of the primary standard was set as 0 ppm, wherein, the total integrated intensity of hydrogen atoms was the value after deducting the integrated intensity of the DMSO solvent (@2.5 ppm). The total integrated intensity of hydrogen atoms in Comparative Example 3 was 40.15, and the integrated intensity of the hydrogen atoms at the terminal C═C (@ 4.95 ppm to 6.00 ppm) was 4.512. That is, the integrated intensity of the hydrogen atoms at the terminal C═C, based on the total integrated intensity, was 11.2%.

### Example 1

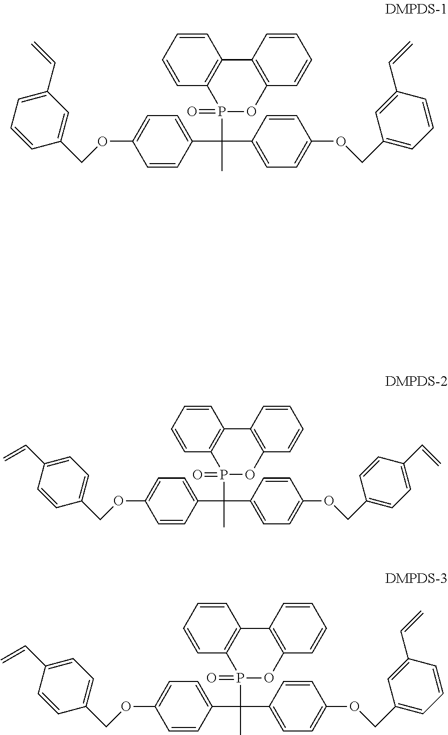

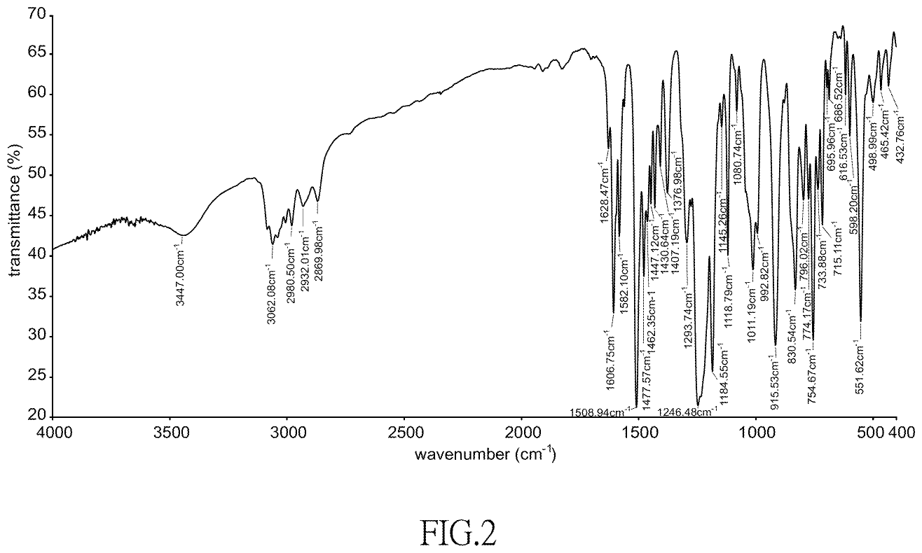

428 g of DMP (as Comparative Example 2 mentioned above) was dissolved in 1 kg of DMSO, and then 176 g of 50 (v/v)% NaOH was added and mixed in uniform. 340 g of CMS-P/0.2 g of MEHQ was dipped into the mixture at 65° C. until complete reaction. After cooling, the phosphorus-containing resin of Example 1 was obtained, whose main product is DMPDS-1, DMPDS-2, and DMPDS-3 as shown above. After the same FT-IR analysis method as mentioned above, with reference to FIG. 2, it was observed that there was an obvious P—O-Ph absorption characteristic peak at 1184 cm⁻¹, an obvious aromatic C—O absorption characteristic peak at 1246 cm⁻¹, an obvious saturated C—O absorption characteristic peak at 1014 cm⁻¹, an obvious C—C styrene group absorption characteristic peak at 1607 cm⁻¹ and 1683 cm⁻¹. P—H absorption characteristic peak at 2436 cm⁻¹ was not observed, and Ph-OH absorption characteristic peak at 3360 cm⁻¹ to 3370 cm⁻¹ was not observed.

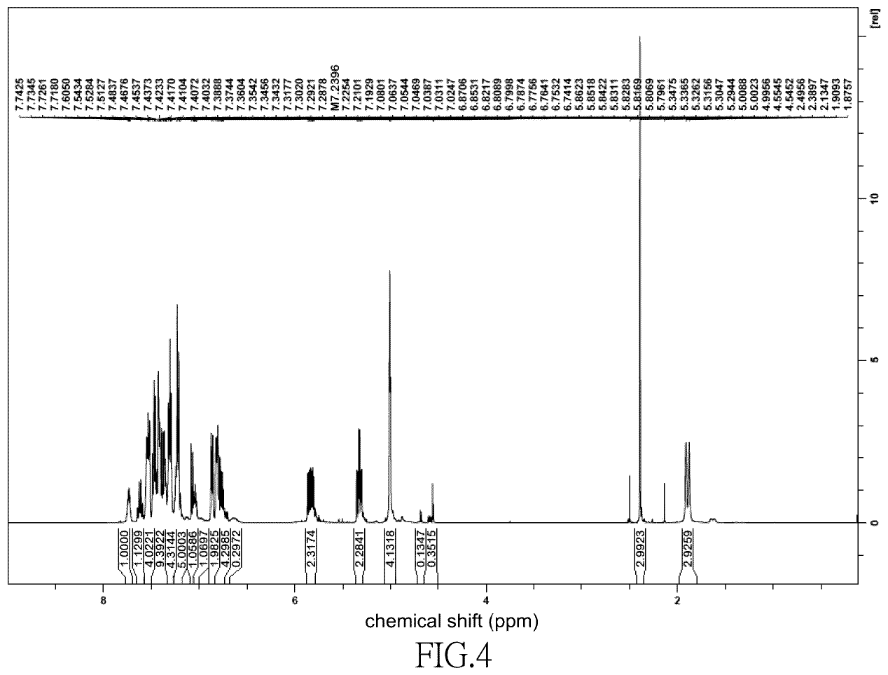

Analyzed by the same 1H-NMR measurement method as described above, the measurement results of 1H-NMR were shown in FIG. 4 and Table 1. The total integrated intensity of hydrogen atoms in Example 1 was 48.7031, and the integrated intensity of the hydrogen atoms at the terminal C═C (@ 4.95 ppm to 6.00 ppm) was 8.7333. That is, the integrated intensity of the hydrogen atoms at the terminal C═C, based on the total integrated intensity, was 17.9%.

TABLE 1
the measurement result of ¹H-NMR of Example 1.

| chemical shift (ppm) | absorption area |
|---|---|
| about 1.88 to 1.9 | 2.9259 |
| about 2.39 | 2.9923 |
| about 4.5 to 4.6 | 0.3515 |
| about 4.7 | 0.1347 |
| about 5.0 | 4.1318 |
| about 5.29 to 5.35 | 2.2841 |
| about 5.8 to 5.9 | 2.3174 |
| about 6.7 | 0.2972 |
| about 6.8 | 4.2985 |
| about 6.9 | 1.9825 |
| about 7.0 | 1.0697 |
| about 7.1 to 7.71 | 1.0586 |
| | 5.0003 |
| | 4.3144 |
| | 9.3922 |
| | 4.0221 |
| | 1.1299 |
| | 1.0000 |

### Example 2

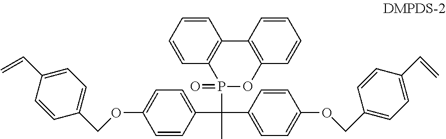 [SMILES: C=Cc1ccc(COc2ccc(C(C)(c3ccc(OCc4ccc(C=C)cc4)cc3)P3(=O)Oc4ccccc4-c4ccccc43)cc2)cc1]

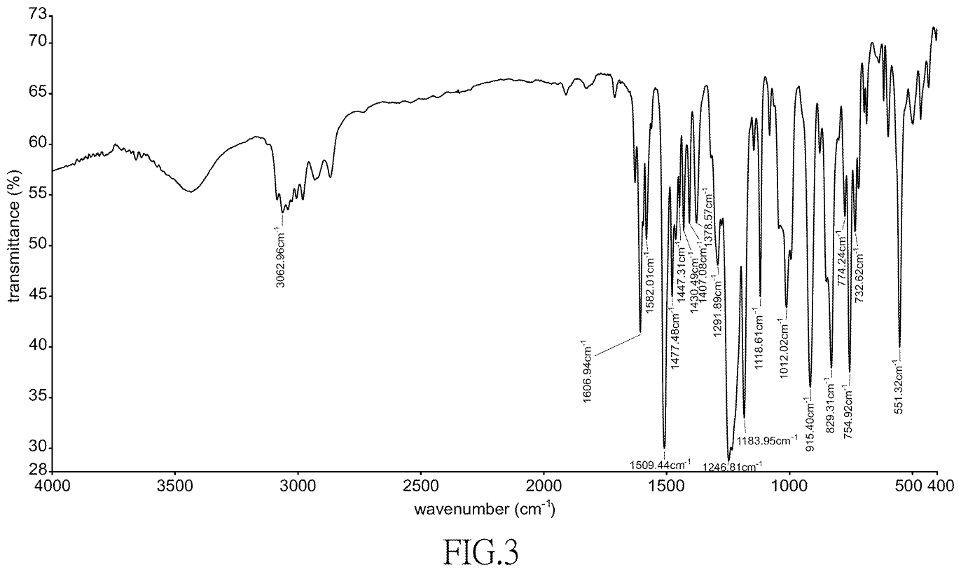

428 g of DMP was dissolved in 1 kg of DMSO, and then 176 g of 50% sodium hydroxide was added and stirred evenly. 340 g of CMS-14/0.2 g of MEHQ at 65° C. were dipped in the mixture until the reaction was complete. After cooling down, Example 2 was obtained. Since the reactant was CMS-14 whose chlorine group and vinyl group were mainly in the para position, the main structure of Example 2 was DMPDS-2 as shown above. After the same FT-IR analysis method as mentioned above, referring to FIG. 3, it was observed that there was an obvious P—O-Ph absorption characteristic peak at 1184 cm⁻¹, an obvious aromatic C—O absorption characteristic peak at 1247 cm⁻¹, an obvious saturated C—O absorption characteristic peak at 1014 cm⁻¹, and an obvious C═C styrene group absorption characteristic peak at 1607 cm⁻¹ and 1683 cm⁻¹. P—H absorption characteristic peak at 2436 cm⁻¹ was not observed, and Ph-OH absorption characteristic peak between 3300 cm⁻¹ and 3370 cm⁻¹ was not observed either.

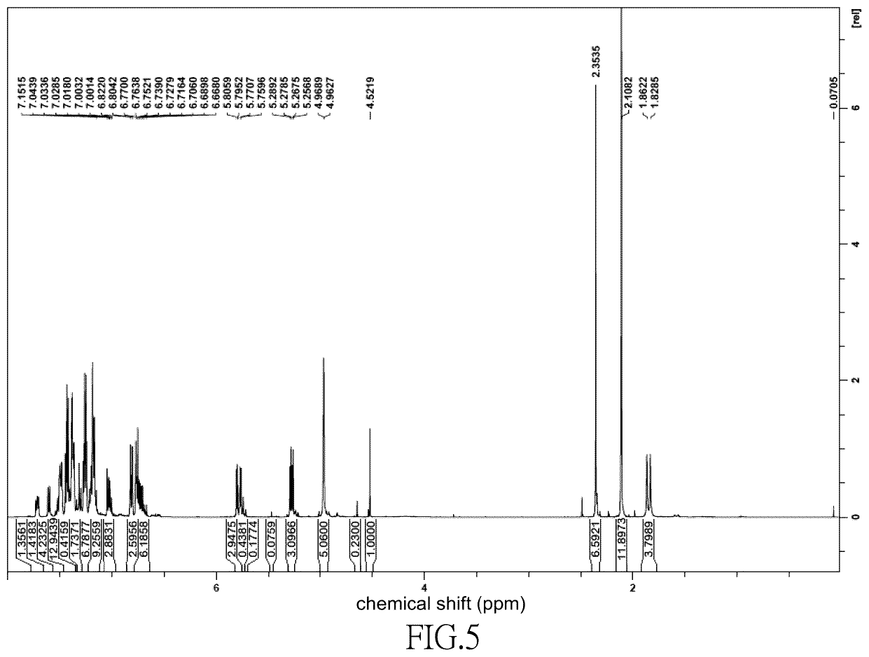

Analyzed by the same 1H-NMR measurement method as described above, as shown in FIG. 5 and Table 2, the total integrated intensity of hydrogen atoms in Example 2 was 85.1257, the integrated intensity of the hydrogen atoms at the terminal C═C (@ 4.95 ppm to 6.00 ppm) was 11.7955. That is, the integrated intensity of the hydrogen atoms at the terminal C═C, based on the total integrated intensity, was 13.9%.

TABLE 2
the measurement result of ¹H-NMR of Example 2.

| Chemical shift (ppm) | absorption area |
|---|---|
| about 1.83 to 1.87 | 3.7989 |
| about 2.1 | 11.8973 |
| about 2.34 | 6.5921 |
| about 4.52 | 1 |
| about 4.65 | 0.23 |
| about 4.96 to 4.97 | 5.06 |
| about 5.26 to 5.29 | 3.0966 |
| about 5.4 | 0.0759 |
| about 5.76 | 0.1774 |
| about 5.78 | 0.4381 |
| about 5.8 | 2.9475 |
| about 6.67 to 6.82 | 6.1858 |
| about 6.9 | 2.5956 |
| about 7.00 to 7.04 | 2.8831 |
| about 7.15 to 7.21 | 9.2559 |
| about 7.3 to 7.73 | 6.7877 |
| | 1.7371 |
| | 0.4159 |
| | 12.9439 |
| | 4.2325 |
| | 1.4183 |
| | 1.3561 |

### Test Example 1: Inductively Coupled Plasma with Atomic Emission Spectrum (Icp-Aes)

2.5 g of Comparative Example 2, Example 1, and Example 2 were each dissolved in 2.5 g of DMSO, referring to the sample preparation steps of EPA 3050B (v. 1996), the phosphorus content was analyzed by an inductively coupled plasma with atomic emission spectroscopy (model: PERKIN ELMER Optima 8300 ICP-AES) after dissolution, and the results were listed in Table 3.

TABLE 3
the phosphorus content of phosphorus-containing resin
of Comparative Example 2, Example 1, and Example 2.

| | Comparative | | |
|---|---|---|---|
| | Example 2 | Example 1 | Example 2 |
| phosphorus content (wt %) | 8.3 | 4.9 | 4.4 |

As seen in Table 3, the phosphorus content of Comparative Example 2 was more than 5 wt %. However, the phosphorus contents of Example 1 and Example 2 were both less than 5 wt %.

### Test Example 2: Gel Permeation Chromatography (GPC)

Comparative Example 2, Example 1, and Example 2 were diluted to 200 ppm by 1,4-epoxybutane (THF), placed in an autosampler (model: Waters 717 plus Autosampler), and transmitted to four GPC columns connected in series (including a TSK gel G3000H_{XL}, a TSK gel G2000H_{XL}, and two TSK gels G1000H_{XL}) for separation by a pump (model: Waters 515 pump) with a flow rate of 1.0 mL/min, and the integral area of the absorption peak at 254 nm was measured by an absorbance detector (model: Waters 2487 Dual A Absorbance Detector). The measurement results of Comparative Example 2, Example 1, and Example 2 were shown in Table 4.

TABLE 4
the GPC measurement results of phosphorus-containing resin
of Comparative Example 2, Example 1, and Example 2.

| | Comparative | | |
|---|---|---|---|
| | Example 2 | Example 1 | Example 2 |
| number average molecular weight | 354 | 412 | 415 |
| (Mn) (g/mol) | | | |
| weight average molecular weight | 408 | 414 | 418 |
| (Mw) (g/mol) | | | |
| Mw/Mn | 1.15 | 1.01 | 1.01 |

Mw/Mn represents the polydispersity index (PDI). As seen in Table 4, the PDI of the phosphorus-containing resin of Example 1 and Example 2 are less than that of Comparative Example 1, showing that the phosphorus-containing resin of Examples 1 and 2 has less dispersity and less byproducts.

### High Dimensional Stability Flame-Retardant and Heat-Resistant Composition

### Example 1A

30.8 g of diallyl bisphenol A (DABPA, CAS No.: 1745-89-7) and 35.8 g of 4,4′-propane-2,2-diyldiphenol-aniline (1:1) (purchased from Regina, product model: BES1-5950, CAS No: 67784-74-1) were taken into a beaker, and an electromagnetic heating stirrer was used to heat up to 130° C. 28.5 g of Example 1 was then added and stirred until clear, and a flame-retardant and heat-resistant composition with 30 wt % of phosphorus-containing resin was made, which was Example 1A.

### Example 2A

30.8 g of DABPA and 35.8 g of 4,4′-propane-2,2-diyldiphenol-aniline (1:1) were taken into a beaker, and an electromagnetic heating stirrer was used to heat up to 130° C. 22.2 g of Example 1 was then added and stirred until clear, and a flame-retardant and heat-resistant composition with 25 wt % of phosphorus-containing resin was made, which was Example 2A.

### Example 3a

30.8 g of DABPA and 35.8 g of 4,4′-propane-2,2-diyldiphenol-aniline (1:1) were taken into a beaker, and an electromagnetic heating stirrer was used to heat up to 130° C. 16.65 g of Example 1 was then added and stirred until clear, and a flame-retardant and heat-resistant composition with 20 wt % of phosphorus-containing resin was made, which was Example 3A.

### Example 4A

30.8 g of DABPA and 35.8 g of 4,4′-propane-2,2-diyldiphenol-aniline (1:1) were taken into a beaker, and an electromagnetic heating stirrer was used to heat up to 130° C. 11.9 g of Example 1 was then added and stirred until clear, and a flame-retardant and heat-resistant composition with 15 wt % of phosphorus-containing resin was made, which was Example 4A.

### Example 5A

30.8 g of DABPA and 35.8 g of 4,4′-propane-2,2-diyldiphenol-aniline (1:1) were taken into a beaker, and an electromagnetic heating stirrer was used to heat up to 130° C. 7.4 g of Example 1 was then added and stirred until clear, and a flame-retardant and heat-resistant composition with 10 wt % of phosphorus-containing resin was made, which was Example 5A.

### Example 6A

30.8 g of DABPA and 35.8 g of 4,4′-propane-2,2-diyldiphenol-aniline (1:1) were taken into a beaker, and an electromagnetic heating stirrer was used to heat up to 130° C. 11.9 g of Example 2 was then added and stirred until clear, and a flame-retardant and heat-resistant composition with 15 wt % of phosphorus-containing resin was made, which was Example 6A.

### Comparative Example 1A

30.8 g of DABPA and 35.8 g of 4,4′-propane-2,2-diyldiphenol-aniline (1:1) were taken into a beaker, and an electromagnetic heating stirrer was used to heat up to 130° C. 11.9 g of Comparative Example 2 was then added and stirred until clear, and a resin composition with 15 wt % of DMP was made, which was Comparative Example 1A.

### Comparative Example 2A

30.8 g of DABPA and 35.8 g of 4,4′-propane-2,2-diyldiphenol-aniline (1:1) were taken into a beaker, and an electromagnetic heating stirrer was used to heat up to 130° C. 11.9 g of Comparative Example 3 was then added and stirred until clear, and a resin composition with 15 wt % of DMPMS was made, which was Comparative Example 2A.

### Comparative Example 3A

30.8 g of DABPA and 35.8 g of 4,4′-propane-2,2-diyldiphenol-aniline (1:1) were taken into a beaker with no phosphorus-containing resin added, and an electromagnetic heating stirrer was used to heat up to 130° C. A resin composition of Comparative Example 3A was made.

### Test Example 2: Measurement of Phosphorus Content

A potassium dihydrogen phosphate solution was used to obtain a standard curve of UV-visible light absorption wavelength at 420 nm. A sulfuric acid and a potassium persulfate were added to the flame-retardant and heat-resistant composition samples of the aforementioned Examples 1A to 6A and Comparative Examples 1A to 3A respectively. After 60 minutes of digestion at 100° C., each sample solution was treated with vanadate-molybdate reagent to form vanadium molybdate phosphate. Each sample was measured through UV-visible light absorption wavelength at 420 nm, and the phosphorus content was finally determined from the standard curve, in units of wt %.

### Test Example 3: UL 94 Vertical Burning Test

The flame-retardant level of each flame-retardant and heat-resistant composition was measured according to the UL 94 vertical burning test. To compare the flame-retardant effects of each flame-retardant and heat-resistant composition, glass fiber cloth 2116 was impregnated in flame-retardant and heat-resistant compositions of Examples 1A to 6A and Comparative Examples 1A to 3A respectively. After baking at 150° C. for 7 minutes, prepregs were made. Next, each prepreg was cut into 13*13 cm² test pieces, and the top and the bottom of the test pieces were covered with copper foils. The test piece was then hot pressed in vacuum at 220° C. for 2 hours. The test piece was cut into 13*1.3 cm² with a shearing machine, and its outer copper foil was peeled off, finally referring to the UL 94 vertical burning test.

According to the UL 94 flame-retardant test standard, the result of V0 level means that after two 10-second flame tests were carried out on the test piece, the burning stopped within 10 seconds without burning and dripping; the V1 level means that after two 10-second flame tests were carried out on the test piece, the burning stopped within 60 seconds without burning and dripping. In this test example, five test pieces were taken from each sample to conduct five UL 94 flame-retardant tests. Each test was performed with a new test piece to retest the flame-retardant effect.

Table 5 listed out the continued burning time (in seconds) of the test piece after removing the flame at the first 10-second flame test and the continued burning time (in seconds) of the test piece after removing the flame at the second 10-second flame test of each test piece in the UL 94 vertical burning test. As shown in Table 5 below, after the first test piece of Example 1A was subjected to the UL 94 vertical burning test, there was no phenomenon of continued burning of the test piece after the flame was removed at the first 10-second flame test, and there was no phenomenon of continued burning of the test piece after the flame was removed at the second 10-second flame test either. On the contrary, after the first test piece of Comparative Example 1A was subjected to the UL 94 vertical burning test, the test piece continued to burn for 13.8 seconds after the flame was removed at the first 10-second flame test, and the test piece continued to burn for 2.6 seconds after the flame was removed at the second 10-second flame test.

### Test Example 4: Glass Transition Temperature (Tg)

The flame-retardant and heat-resistant compositions of the aforementioned Examples 1A to 6A and Comparative Examples 1A to 3A were used as samples and measured using a differential scanning calorimeter (DSC) according to IPC-TM-650-2.4.25, wherein the scanning rate of the differential scanning calorimeter was 20° C./min.

TABLE 5
The test result of the UL 94 vertical burning test, the glass
transition temperature, and the phosphorus content (P content)
of Examples 1A to 6A and Comparative Examples 1A to 3A.

| | UL 94 vertical burning test | | | | | Tg | P content |
|---|---|---|---|---|---|---|---|
| | 1 | 2 | 3 | 4 | 5 | (° C.) | (wt %) |
| Example 1A | 0/0 | 0/0 | 0/0 | 0/0 | 0/0 | 202 | 1.41 |
| Example 2A | 4.0/0 | 2.8/0 | 5.2/0 | 2.2/0 | 5.6/0 | 209 | 1.18 |
| Example 3A | 4.0/0 | 8.5/0 | 7.0/0 | 7.0/0 | 6.1/0 | 223 | 0.94 |
| Example 4A | 6.3/0 | 8.8/0 | 6.9/0 | 7.0/0 | 6.1/0 | 238 | 0.71 |
| Example 5A | 8.9/0 | 9.9/0 | 8.3/0 | 8.1/0 | 8.6/0 | 256 | 0.47 |
| Example 6A | 5.7/0 | 7.1/0 | 7.5/0 | 5.8/0 | 7.7/0 | 247 | 0.71 |
| Comparative | 13.8/2.6 | 16.1/1.5 | 13.3/3.4 | 5.7/0 | 12.9/2.7 | 187 | 1.08 |
| Example 1A | | | | | | | |
| Comparative | 11.5/2.3 | 12.6/3.8 | 8.9/1.1 | 9.6/1.9 | 10.2/2.5 | 182 | 0.86 |
| Example 2A | | | | | | | |
| Comparative | 18.2/1.6 | 16.6/1.7 | 16.1/2.5 | 17.4/0.9 | 17.9/3.8 | 270 | 0 |
| Example 3A | | | | | | | |

As shown in Table 5 above, the phosphorus-containing resins of Example 1 and Example 2 both had excellent reactivity and may crosslink with maleimide-based resins to produce flame-retardant and heat-resistant compositions comprising the maleimide-based resin. It was seen from Table 5 that the five UL 94 vertical burning tests of Examples 1A to 6A all stopped within 10 seconds without burning and dripping. The five flame-retardant levels were all V0, showing that Examples 1A to 6A had excellent flame resistance. In comparison to Comparative Examples 1A to 3A, since the resin composition of Comparative Example 3A did not add any phosphorus-containing resins, its five flame-retardant levels were all merely V1; the resin composition of Comparative Example 1A (produced from Comparative Example 2) had a four out of five flame-retardant levels being V1; and the resin composition of Comparative Example 2A (produced from Comparative Example 3) had a three out of five flame-retardant levels being V1. It can be seen that although adding 15 wt % of DMP or DMPDS, the flame resistance of the resin compositions of Comparative Examples 1A and 2A was apparently inferior to the flame resistance of the flame-retardant and heat-resistant compositions of Examples 1A to 6A. Further, the glass transition temperatures of Examples 1A to 6A were between 200° C. and 260° C., which shows that they had excellent heat resistance. Compared with Comparative Examples 1A and 2A, their glass transition temperatures were only 182° C. and 187° C., which were both much lower than the flame-retardant and heat-resistant compositions of Examples 1A to 6A.

Referring to Table 5, Examples 4A and 6A and Comparative Examples 1A and 2A were all produced from adding 15 wt % of phosphorus-containing resin. However, the phosphorus content of Examples 4A and 6A was merely 0.71 wt %, the phosphorus content of Comparative Example 1A was 1.08 wt %, and the phosphorus content of Comparative Example 2A was 0.86 wt %, which were both higher than the phosphorus content of Examples 4A and 6A. It showed that the flame-retardant and heat-resistant compositions synthesized from the phosphorus-containing resin of the instant disclosure indeed achieved even better flame resistance and heat resistance at a lower phosphorus content.

### Low Dielectric Flame-Retardant Composition

### Example 1B

25 g of methacrylate polyphenylene oxide resin (abbreviated as PPO, purchased from Sabic Corporation, model: SA9000) and 10 g of triallyl-isocyanurate (abbreviated as TAIC, CAS No.: 1025-15-6) were taken into a beaker, and an electromagnetic heating stirrer was used to heat up to 90° C. 8.75 g of Example 2 was then added and stirred evenly. The temperature was continuingly raised to 100° C. for 5 minutes, and the gel time at 171° C. was 400 seconds. A flame-retardant and heat-resistant composition with 20 wt % of phosphorus-containing resin was made, which was Example 1B.

### Example 2B

25 g of PPO and 10 g of TAIC were taken into a beaker, and an electromagnetic heating stirrer was used to heat up to 90° C. 6.2 g of Example 2 was then added and stirred evenly. The temperature was continuingly raised to 100° C. for 5 minutes, and the gel time at 171° C. was 450 seconds. A flame-retardant and heat-resistant composition with 15 wt % of phosphorus-containing resin was made, which was Example 2B.

### Example 3B

25 g of PPO and 10 g of TAIC were taken into a beaker, and an electromagnetic heating stirrer was used to heat up to 90° C. 8.75 g of Example 2 was then added and stirred evenly. The temperature was then cooled to 50° C., and 0.05 g of benzoyl peroxide (CAS No.: 94-36-0) was added. A flame-retardant and heat-resistant composition with 20 wt % of phosphorus-containing resin was made, which was Example 3B.

### Example 4B

25 g of PPO and 10 g of TAIC were taken into a beaker, and an electromagnetic heating stirrer was used to heat up to 90° C. 6.2 g of Example 2 was then added and stirred evenly. The temperature was then cooled to 50° C., and 0.05 g of benzoyl peroxide was added. A flame-retardant and heat-resistant composition with 15 wt % of phosphorus-containing resin was made, which was Example 4B.

### Comparative Example 1B

25 g of PPO and 10 g of TAIC were taken into a beaker, and an electromagnetic heating stirrer was used to heat up to 90° C. 6.2 g of Comparative Example 2 was then added and stirred evenly. The temperature was then cooled to 50° C., and 0.05 g of benzoyl peroxide was added. A resin composition with 15 wt % of phosphorus-containing resin was made, which was Comparative Example 1B.

### Comparative Example 2B

25 g of PPO and 10 g of TAIC were taken into a beaker, and an electromagnetic heating stirrer was used to heat up to 90° C. 6.2 g of Comparative Example 3 was then added and stirred evenly. The temperature was then cooled to 50° C., and 0.05 g of benzoyl peroxide was added. A resin composition with 15 wt % of phosphorus-containing resin was made, which was Comparative Example 2B.

Examples 1B to 4B and Comparative Examples 1B to 2B were subjected to the UL 94 vertical burning test as the method described above, and their phosphorus contents and glass transition temperatures were measured. The results were recorded in Table 6 below. Specifically, to compare the flame-retardant effect of the flame-retardant and heat-resistant compositions, glass fiber cloth 2116 was impregnated in flame-retardant and heat-resistant compositions of Examples 1B to 4B and Comparative Examples 1B to 2B respectively. After baking at 150° C. for 7 minutes, prepregs were made. Next, each prepreg was cut into 13*13 cm² test pieces, and the top and the bottom of the test pieces were covered with copper foils. The test piece was then hot pressed in vacuum at 220° C. for 2 hours. The test piece was cut into 13*1.3 cm² with a shearing machine, and its outer copper foil was peeled off, finally referring to the UL 94 vertical burning test.

TABLE 6
The test result of UL 94 vertical burning test, the glass transition
temperatures, and the phosphorus contents (P content) of Examples
1B to 4B and Comparative Examples 1B to 2B.

| | UL 94 vertical burning test | | | | | Tg | P content |
|---|---|---|---|---|---|---|---|
| | 1 | 2 | 3 | 4 | 5 | (° C.) | (wt %) |
| Example 1B | 6.0/0 | 6.4/0 | 7.9/0 | 4.3/0 | 5.2/0 | 207 | 0.94 |
| Example 2B | 5.9/0 | 5.8/0 | 1.3/0 | 8.4/0 | 2.4/1.2 | 198 | 0.71 |
| Example 3B | 2.1/0 | 3.7/0 | 3.1/0 | 2.3/0 | 5.9/0 | 219 | 0.94 |
| Example 4B | 2.5/0 | 2.1/0 | 2.9/0 | 2.2/0 | 2.8/0 | 206 | 0.71 |
| Comparative | 14.8/2.2 | 16.5/1.8 | 7.5/0 | 12.3/1.0 | 6.9/0 | 155 | 1.08 |
| Example 1B | | | | | | | |
| Comparative | 8.5/0 | 8.9/0 | 10.6/0.8 | 11.4/1.1 | 11.8/2.2 | 174 | 0.85 |
| Example 2B | | | | | | | |

The phosphorus-containing resin of the instant disclosure had excellent reactivity, so that it can crosslink with polyphenylene oxide-based resin to produce flame-retardant and heat-resistant compositions comprising polyphenylene oxide-based resins. It can be seen from Table 6 that the five UL 94 vertical burning tests of Examples 1B to 4B all stopped within 10 seconds without burning and dripping. The five flame-retardant levels were all V0, showing that the flame-retardant and heat-resistant compositions of Examples 1B to 4B had excellent flame resistance. In contrast, there were three out of five flame-retardant levels of Comparative Example 1B and 2B being V1, showing that the flame resistance of the resin compositions of Comparative Examples 1B and 2B were inferior to the flame-retardant and heat-resistant compositions of Examples 1B to 4B. On the other hand, the glass transition temperatures of Examples 1B to 4B were between 190° C. and 220° C., which were apparently higher than the glass transition temperatures of Comparative Examples 1B and 2B. It was shown that the flame-retardant and heat-resistant compositions of Examples 1B to 4B had excellent heat resistance.

In summary, the phosphorus-containing resin of the instant disclosure had excellent reactivity, making it able to crosslink and form bonds with a variety of resin materials. The flame-retardant and heat-resistant composition prepared by the phosphorus-containing resin not only had good flame resistance and heat resistance, but also had extremely low phosphorus content, making the phosphorus-containing resin of the instant disclosure having high industrially applicability and high commercial value.

What is claimed is:

1. A phosphorus-containing resin, comprising a structure represented in Formula (I): 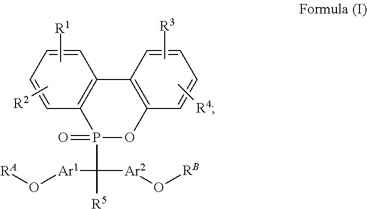
wherein R¹, R², R³, and R⁴ are each independently selected from the group consisting of a hydrogen atom, an alkyl group having 1 to 6 carbon atoms, an alkoxy group having 1 to 6 carbon atoms, and a cycloalkyl group having 3 to 6 carbon atoms;
R⁵ is selected from the group consisting of an alkyl group having 1 to 6 carbon atoms, an alkoxy group having 1 to 6 carbon atoms, a cycloalkyl group having 3 to 6 carbon atoms, and Ar³;
R^{A} and R^{B} are each independently 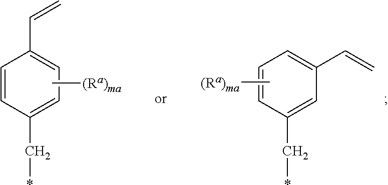
Ar¹ and Ar² are each independently selected from the group consisting of 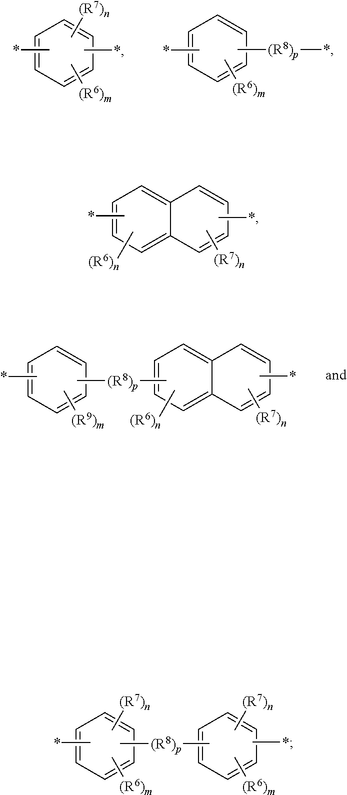
Ar³ is selected from the group consisting of 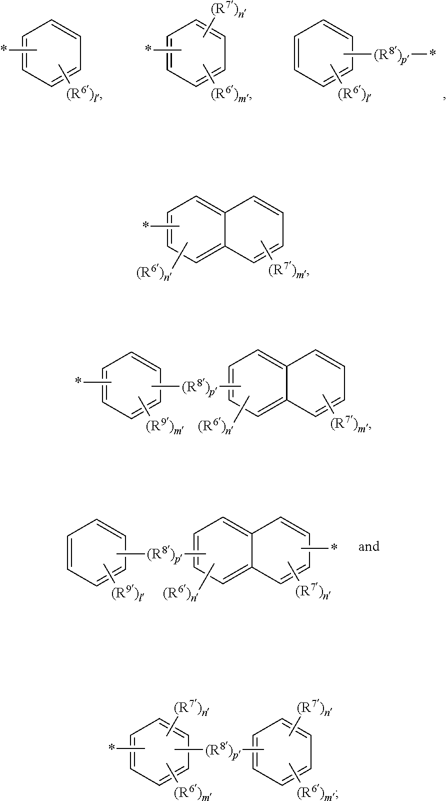
R⁶, R⁷, R⁹, R^{6′}, R⁷, R^{9′}, and R^{a} are each independently selected from 4 the group consisting of an alkyl group having 1 to 6 carbon atoms, an alkoxy group having 1 to 6 carbon atoms, and a cycloalkyl group having 3 to 6 carbon atoms;
R⁸ and R^{8′} are each independently selected from the group consisting of —CH₂—, —C(CH₃)₂—, —CO—, —SO₂—, and —O—;
l′ is an integer of 0 to 5;
m, m′, and ma are each independently an integer of 0 to 4;
n and n′ are an integer of 0 to 3;
p and p′ are 0 or 1;
the sum of m and n is not more than 4;
the sum of m′ and n′ is not more than 5; and
*represents the bonding site.

2. The phosphorus-containing resin as claimed in claim 1, wherein R^{A} and R^{B} are each independently

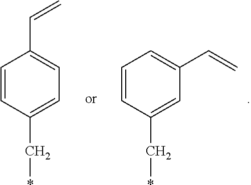

3. The phosphorus-containing resin as claimed in claim 1, wherein Ar¹ and Ar² are each independently selected from the group consisting of 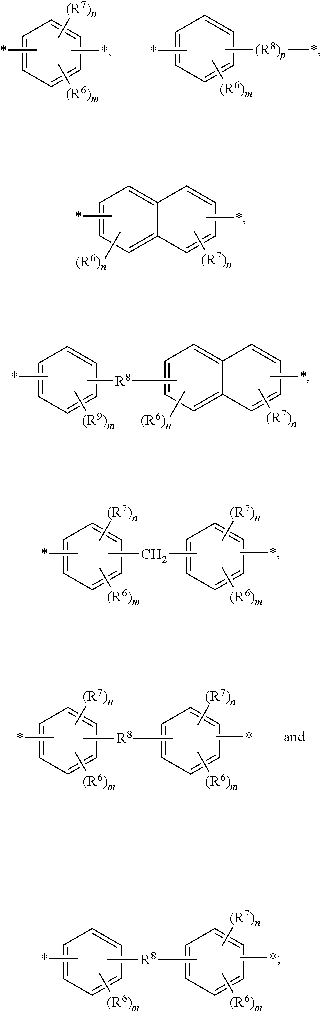
R⁶, R⁷, and R⁹ are each independently selected from the group consisting of an alkyl group having 1 to 4 carbon atoms, an alkoxy group having 1 to 4 carbon atoms, and a cycloalkyl group having 3 to 6 carbon atoms;
R⁸ is selected from the group consisting of —CH₂—, —C(CH₃)₂—, —CO—, —SO₂—, and —O—; and
m, n, and p are each independently 0 or 1.

4. The phosphorus-containing resin as claimed in claim 1, wherein Ar³ is selected from a group consisting of 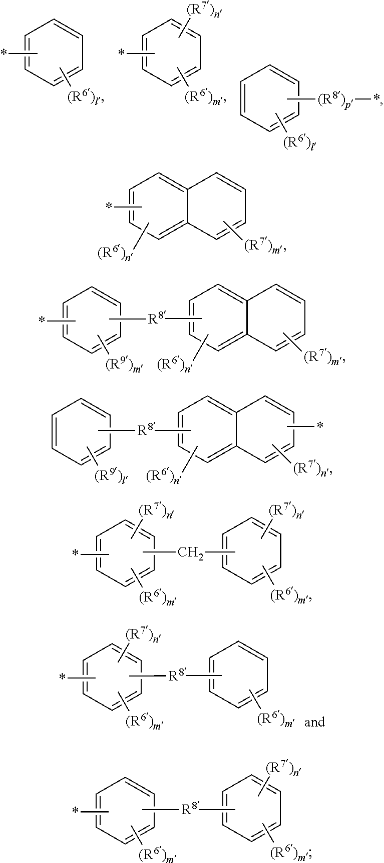
R⁶, R⁷, and R⁹ are each independently selected from the group consisting of an alkyl group having 1 to 4 carbon atoms, an alkoxy group having 1 to 4 carbon atoms, and a cycloalkyl group having 3 to 6 carbon atoms;
R^{8′} is selected from the group consisting of —CH₂—, —C(CH₃)₂—, —CO—, —SO₂—, and —O—; and
l′, m′, n′, and p′ are each independently 0 or 1.

5. The phosphorus-containing resin as claimed in claim 1, wherein R⁵ is —CH₃ or —C₆H₅.

6. The phosphorus-containing resin as claimed in claim 1, wherein the proton nuclear magnetic resonance (1H-NMR) spectrum of the phosphorus-containing resin includes a characteristic peak at 4.95 ppm to 6.00 ppm, and an integral value of the characteristic peak at 4.95 ppm to 6.00 ppm relative to a total integral value of characteristic peaks of hydrogen atoms of the phosphorus-containing resin is 10% to 20%.

7. The phosphorus-containing resin as claimed in claim 1, wherein a phosphorus content of the phosphorus-containing resin is less than 5 wt % based on the total weight of the phosphorus-containing resin.

8. The phosphorus-containing resin as claimed in claim 7, wherein the phosphorus content of the phosphorus-containing resin is more than 1 wt % and less than 5 wt %.

9. The phosphorus-containing resin as claimed in claim 1, wherein the Fourier-transform infrared (FT-IR) spectrum of the phosphorus-containing resin has an absorption peak at 1600 cm⁻¹ to 1700 cm⁻¹ corresponding to C═C of alkene.

10. The phosphorus-containing resin as claimed in claim 1, wherein the FT-IR spectrum of the phosphorus-containing resin has an absorption peak at 1240 cm⁻¹ to 1250 cm⁻¹ corresponding to C—O of aromatic compound.

11. The phosphorus-containing resin as claimed in claim 1, wherein the FT-IR spectrum of the phosphorus-containing resin has an absorption peak at 1180 cm⁻¹ to 1195 cm⁻¹ corresponding to P—O-Ph.

12. A flame-retardant and heat-resistant composition comprising the phosphorus-containing resin as claimed in claim 1 and a main resin.

13. The flame-retardant and heat-resistant composition as claimed in claim 12, wherein a content of the phosphorus-containing resin is 5 wt % to 50 wt % based on the total weight of the overall flame-retardant and heat-resistant composition.

14. The flame-retardant and heat-resistant composition as claimed in claim 12, wherein the flame-retardant and heat-resistant composition has a phosphorus content of 0.5 wt % to 1.5 wt % based on the total weight of the overall flame-retardant and heat-resistant composition.

15. The flame-retardant and heat-resistant composition as claimed in claim 12, wherein the flame-retardant and heat-resistant composition has a glass transition temperature of 190° C. to 300° C.

16. The flame-retardant and heat-resistant composition as claimed in claim 12, wherein the main resin comprises polyphenylene oxide-based resin, maleimide-based resin or a combination thereof.
